(19) United States
(12) Patent Application Publication
(10) Pub. No.: US 2009/0116105 A1
(43) Pub. Date: May 7, 2009

(54) Binocular telescope with adjustable prism module

(75) Inventor: Chun-Mao Lee, Taipei (TW)

Correspondence Address: BACON & THOMAS, PLLC, 625 SLATERS LANE, FOURTH FLOOR, ALEXANDRIA, VA, 22314-1176, US

(73) Assignee: Foshan City Nanhai Weihong Mold Products Co., Ltd., Foshan City (CN)

(21) Appl. No.: 11/979,319

(22) Filed: Nov. 1, 2007

(51) Int. Cl. G02B 23/00

(52) U.S. Cl. 359/407; 359/431

(57) ABSTRACT

In a binocular telescope with an adjustable prism module, an eyepiece lens module, a prism module and an objective lens module are installed inside a telescope tube of the binocular telescope. The prism module includes a prism base, a first right-angle prism, a Porro prism, a second right-angle prism and a support base, and an exit surface of the first right-angle prism is connected with an incident surface of the Porro prism, and the second right-angle prism is set on the support base, and the incident surface of the second right-angle prism is attached to the Porro prism. The first and second right-angle prisms can be adjusted to change the angle of optical axes among the prism module, the eyepiece lens module and the objective lens module to prevent a distortion of the optical imaging.

### FIELD OF THE INVENTION

The present invention relates to a binocular telescope, and more particularly to a binocular telescope with an adjustable prism module.

### BACKGROUND OF THE INVENTION

In general, an optical system of a traditional binocular telescope is composed of a cemented doublet objective lens, a Porro prism and an eyepiece lens, wherein the cemented doublet objective lens is a magnifying glass, and a side of the cemented doublet objective lens is used for collecting the light of a remote object and converts an image of the remote object into a reduced and inverted real image, and the cemented doublet objective lens faces a side of the Porro prism and sends the reduced and inverted real image to a side of the Porro prism that faces the cemented doublet objective lens, such that the Porro prism converts the reduced and inverted real image into an erected real image, and the Porro prism faces a side of the eyepiece lens and sends the erected real image to a side of the eyepiece lens that faces the Porro prism, and the eyepiece lens amplifies the erected real image to an erected optical imaging visible by users.

Based on the description above, users can view the optical imaging through the binocular telescope, and the vision range of the optical imaging is determined completely by an optical system composed of the cemented doublet objective lens, the Porro prism and the eyepiece lens. Therefore, the condition of the optical axes of the cemented doublet objective lens, the Porro prism and the eyepiece lens being linear without any shifting or tilting during a manufacturing process of the binocular telescope has a substantial effect on the quality of the binocular telescope.

If the optical axes of the cemented doublet objective lens, the Porro prism and the eyepiece lens are shifted or tilted, the optical imaging viewed by users may be distorted by an overlap of images, and the poor optical imaging may cause tiredness or ache to the user's eyes and dizziness or nausea easily if a user keeps viewing the distorted images for some time. After the user continues viewing such images for an hour, the user's vision may be damaged greatly. Therefore, it is an important subject for manufacturers to find a way of overcoming the aforementioned problems of blurred images and non-parallel axes.

### SUMMARY OF THE INVENTION

In view of the shortcomings of the prior art, the inventor of the present invention based on years of experience in the related industry to conduct extensive researches and experiments, and finally developed a binocular telescope with an adjustable prism module in accordance with the present invention to overcome the aforementioned problems of the shifted or tilted optical axis.

It is a primary objective of the present invention to provide a binocular telescope with an adjustable prism module, wherein an eyepiece lens module, a prism module and an objective lens module are installed sequentially from one end to another end inside a telescope tube of the binocular telescope, and the prism module and the objective lens module are installed in a telescope body of the telescope tube, so that an image of a remote object can go through the optical effects of the objective lens module, the prism module and the eyepiece lens module, such that users can view an optical imaging from the eyepiece lens module. The prism module comprises a prism base, a first right-angle prism, a Porro prism, a second right-angle prism and a support base, wherein an exit surface of the first right-angle prism is connected with a portion of an incident surface of the Porro prism, and the second right-angle prism is movably set on the support base, and the incident surface of the second right-angle prism is attached to another portion of the Porro prism, such that if the optical axes of the objective lens module and the prism module, or the prism module and the eyepiece lens module are shifted or tilted, the binocular telescope will have a distortion of the optical imaging. By adjusting the position of the first right-angle prism that faces the objective lens module, and the position of the second right-angle prism that faces the eyepiece lens module, we can change the angle of optical axes among the prism module, the eyepiece lens module and the objective lens module, so that the optical imaging will not be distorted, so as to overcome the distortion of the optical imaging occurred easily in a traditional binocular telescope.

### BRIEF DESCRIPTION OF THE DRAWINGS

FIG. 1 is a section view of a telescope tube of the present invention;

FIG. 2 is another section view of a telescope tube of the present invention;

FIG. 3 is a schematic structural view of a prism module of the present invention;

FIG. 4 is a schematic structural view of a second right-angle prism and a support base of the present invention;

FIG. 5 is an exploded view of telescope body and prism module of the present invention; and

FIG. 6 is another schematic view of a telescope tube of the present invention.

### DETAILED DESCRIPTION OF THE PREFERRED EMBODIMENTS

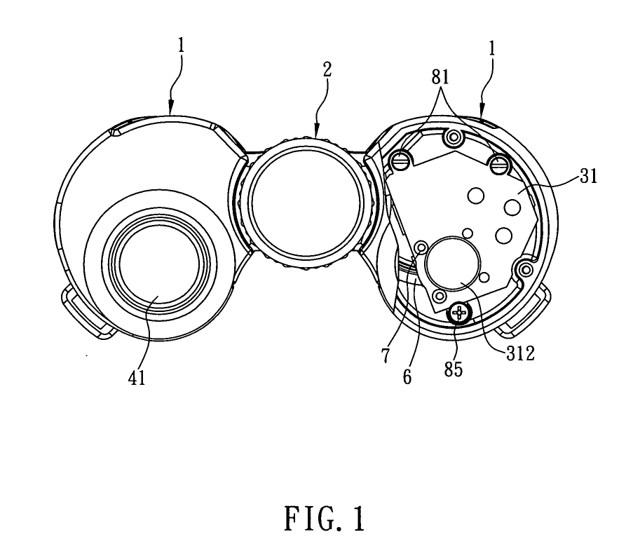

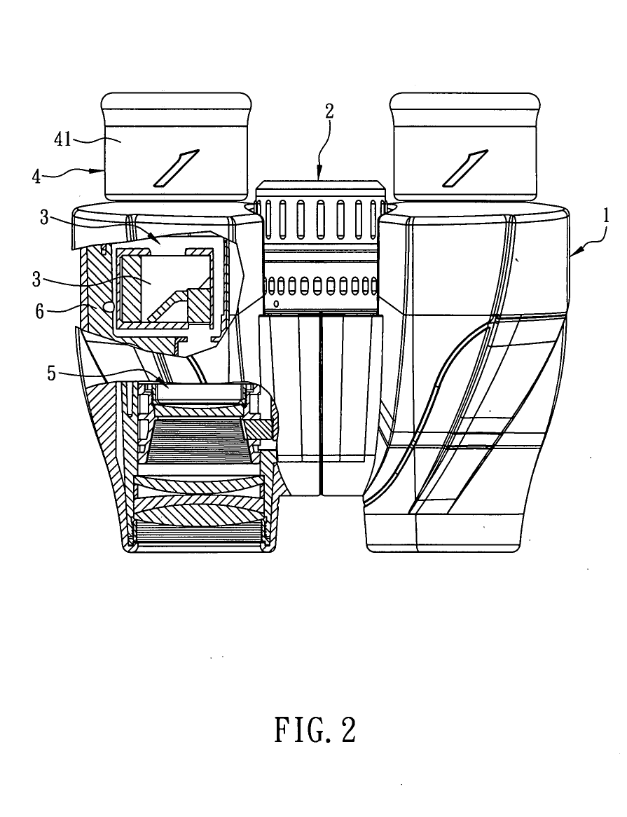

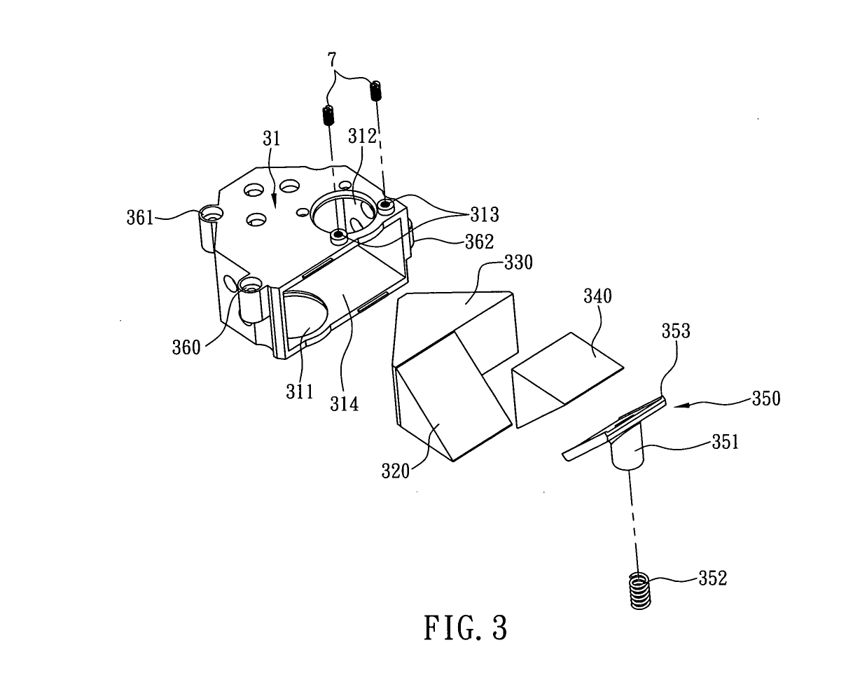

Referring to FIGS. 1 and 2 for a binocular telescope with an adjustable prism module in accordance with the present invention, the binocular telescope comprises two telescope tubes 1 and a base shaft 2, wherein the two telescope tubes 1 are pivotally coupled to two corresponding lateral sides of the base shaft 2 respectively, and an end of each telescope tube 1 has an eyecup unit 41, and the eyecup unit 41 includes an eyepiece lens module 4 therein, and each telescope tube 1 includes a telescope body 6, and a prism module 3 and an objective lens module 5 installed sequentially from one end to another end of the telescope body 6 and proximate to the eyepiece lens module 4. If a user views a remote object by the binocular telescope, the user's eye is in contact with the eyecup unit 41 to view an optical imaging of a remote object through the objective lens module 5, the prism module 3 and the eyepiece lens module 4. In FIG. 3, the prism module 3 comprises a prism base 31, a first right-angle prism 320, a Porro prism 330 and a second right-angle prism 340, wherein the bottom surface of the prism base 31 has a first opening 311, and the top surface of the prism base 31 has a second opening 312, and the prism base 31 is movably set at a position between the eyepiece lens module 4 and the objective lens module 5 in the telescope body 6, and the prism base 31 includes a containing space 314 disposed therein and interconnected with each opening 311, 312 for containing the prisms, and the first right-angle prism 320 is disposed in the prism base 31 and at a position facing the first opening 311, and an incident surface of the first right-angle prism 320 precisely faces the first opening 311 and corresponds to the objective lens module 5 through the first opening 311 and has an interval from the objective lens module 5, and the second right-angle prism 340 is disposed inside the prism base 31 and at a position facing the second opening 312, and the exit surface of the second right-angle prism 340 precisely faces the second opening 312. Further, the incident surface of the second right-angle prism 340 is attached to another portion of the exit surface of the Porro prism 330 and corresponds to the eyepiece lens module 4 through the second opening 312 with an interval from the eyepiece lens module 4, wherein the position of the prism base 31 in the telescope tube 1 is adjusted to change the angle of optical axis between the incident surface of the first right-angle prism 320 and the objective lens module 5, and the position of the second right-angle prism 340 in the prism base 31 is adjusted to change the angle of optical axis between the exit surface of the second right-angle prism 340 and the eyepiece lens module 4, while changing the angle of optical axis between the incident surface of the second right-angle prism 340 and another portion of the incident surface of the Porro prism 330. If the optical imaging produced by the binocular telescope is shifted or tilted, the optical imaging projected onto the exit surface of the second right-angle prism 340 will no longer be shifted or tilted by adjusting the position of the second right-angle prism 340 inside the prism module 3 and facing another portion of the incident surface of the Porro prism 330, so as to improve the quality of binocular telescope and lower the production cost effectively.

In the embodiment as shown in FIGS. 2 and 3, the prism module 3 includes a support base 350 disposed inside the prism base 31, and having an oblique plane portion 353 pressed against a reflecting surface of the second right-angle prism 340, and the support base 350 includes a hollow support pillar 351 disposed at a position with its back facing the second right-angle prism 340, and the hollow support pillar 351 includes a first resilient element 352 with a free end pressing against the interior of the prism base 31, and the top surface of the prism base 31 has at least one penetrating screw hole 313 disposed around the periphery of the second opening 312, and each penetrating screw hole 313 is provided for passing a first adjusting element 7, and each first adjusting element 7 is extended into the containing space 314 and pressed against the exit surface of the second right-angle prism 340.

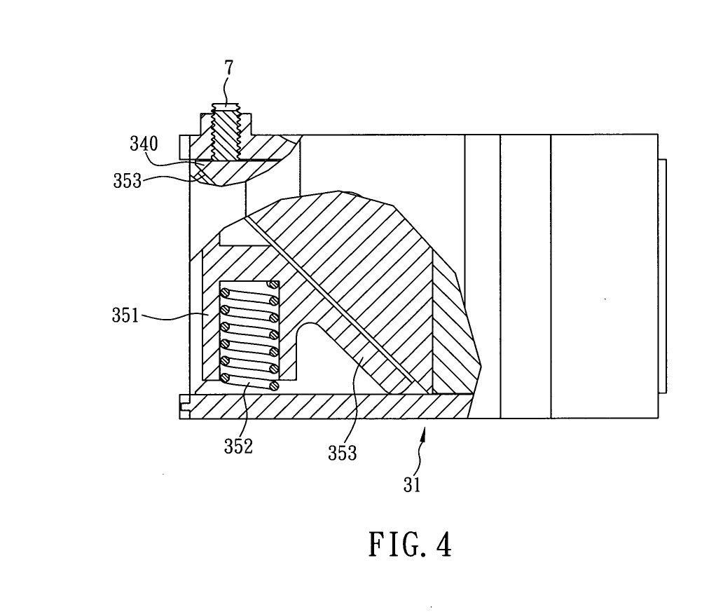

In FIGS. 3 and 4, if a user wants to adjust the prism module 3 and the eyepiece lens module 4 to correct the optical axis, the user can observe whether or not the lights along the optical axes of the second right-angle prism 340 and the eyepiece lens module 4 at the eyecup unit 41 are linear. If the user finds out that the optical axes of the second right-angle prism 340 and the eyepiece lens module 4 are nonlinear and a distortion of image is formed, the user can adjust the depth of extending each first adjusting element 7 into the containing space 314 to change the position of the exit surface of the second right-angle prism 340 that faces the eyepiece lens module 4, so as to adjust the angle of optical axis between the second right-angle prism 340 and the eyepiece lens module 4 and the angle of optical axis between the second right-angle prism 340 and another portion of the Porro prism 330 until the light at the exit surface second right-angle prism 340 and the light at the optical axis of the eyepiece lens module 4 are linear, and the light at the incident surface of the second right-angle prism 340 and the light at the optical axis of another portion of the Porro prism 330 are linear, so as to complete adjusting the angle of optical axis between the second right-angle prism 340 and the eyepiece lens module 4 and the angle of optical axis between the second right-angle prism 340 and the Porro prism 330.

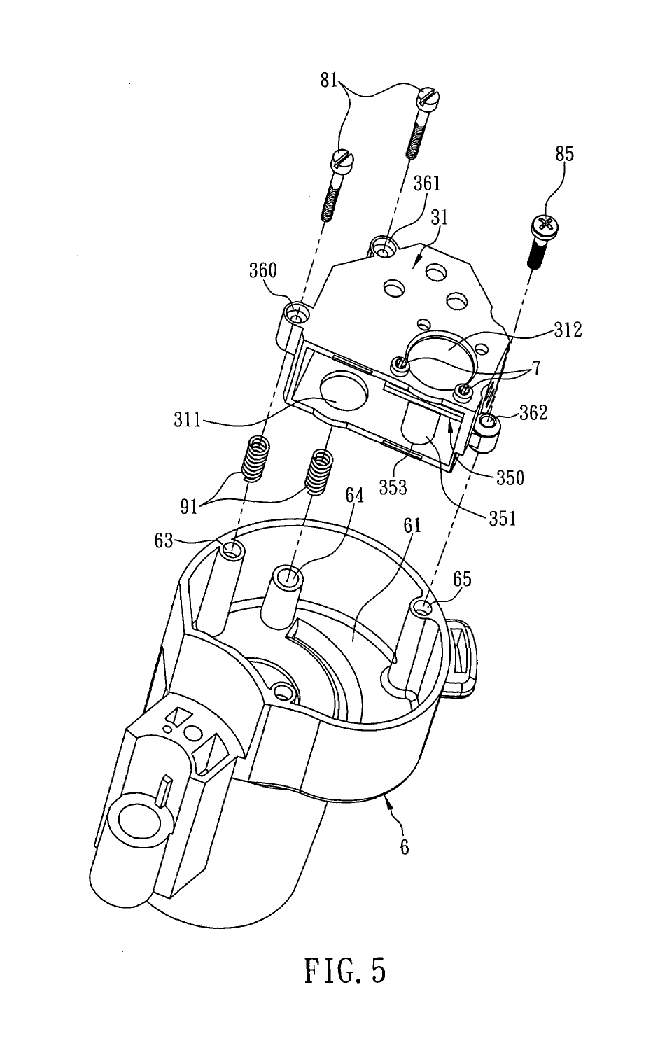

In the embodiment as shown in FIG. 5, the telescope body 6 has a containing groove 61 in a corresponding shape of the prism base 31 and disposed at a position facing an end of the eyepiece lens module 4, and the containing groove 61 has a first containing hole 63, a second containing hole 64 and a fixing through hole 65 disposed inside the containing groove 61 and at a position proximate to its sidewall, wherein the first containing hole 63 and the second containing hole 64 separately include a second resilient element 91, and the prism base 31 is disposed in the containing groove 61 and has a first connecting hole 360, a second connecting hole 361 and a locking hole 362 disposed around the periphery of the prism base 31 and at positions facing the first containing hole 63, the second containing hole 64 and the fixing hole respectively. The locking hole 362 is provided for passing a connecting element 85, and the connecting element 85 is extended into the fixing through hole 65 for adjusting a fulcrum at the position of the prism base 31 in the telescope tube 1. The first connecting hole 360 and the second connecting hole 361 separately include a second adjusting element 81, and each second adjusting element 81 is extended separately into the first containing hole 63 and the second containing hole 64.

After the objective lens module 5 has received the optical imaging, the optical imaging is incident from the first opening 311 onto the incident surface of the first right-angle prism 320, and refracted from the refracting surface of the first right-angle prism 320, and then incident from the exit surface of the first right-angle prism 320 into the Porro prism 330. After the light of the optical imaging is reflected from two reflecting surfaces of the Porro prism 330 to the incident surface of the second right-angle prism 340, and reflected from the reflecting surface of the second right-angle prism 340, the optical imaging can pass through the second opening 312 into the eyecup unit 41. Now, the user can view the optical imaging through the eyecup unit 41.

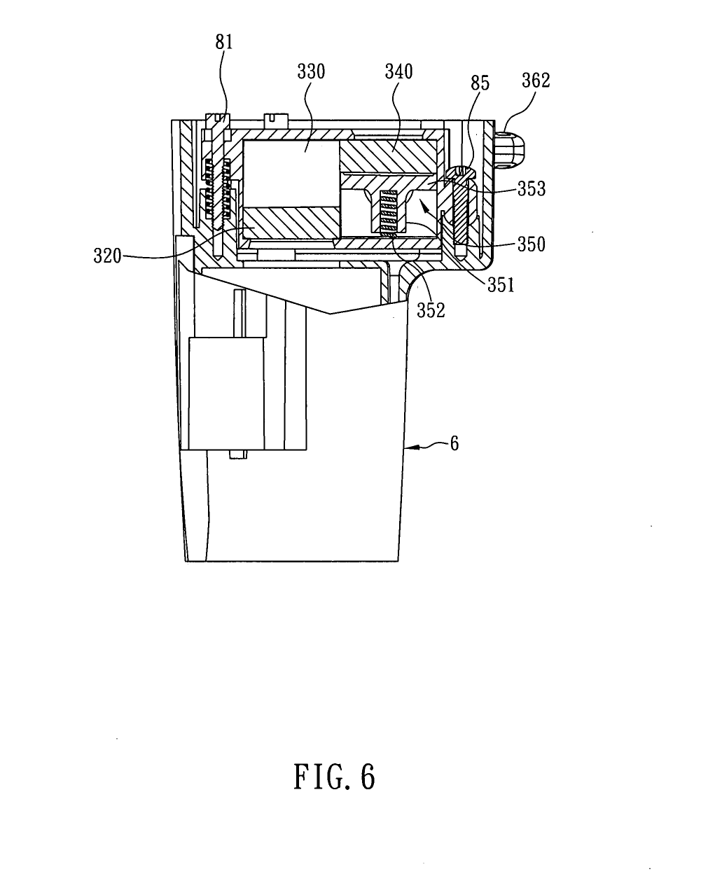

In FIGS. 5 and 6, if a user wants to adjust the prism module 3 and the objective lens module 5 to correct the optical axis, the user can observe whether or not the optical axes of the first right-angle prism 320 and the objective lens module 5 are linear. If the user finds out that the optical axes of the first right-angle prism 320 and the objective lens module 5 are nonlinear, then the user can adjust the depth of extending each second adjusting element 81 into the first containing hole 63 and the second containing hole 64 to change the position of the prism base 3 in the containing groove 61, so that the angle of optical axis between the incident surface of the first right-angle prism 320 and the objective lens module 5 is changed until the light at the incident surface of the first right-angle prism 320 and the light at the optical axis of the objective lens module 5 are linear to effectively overcome the problems of a nonparallel optical axis and an optical imaging distortion of the traditional binocular telescope, so as to improve the quality of the binocular telescope and lower the production cost.

It is noteworthy to point out that when a user adjusts the depth of extending each second adjusting element 81 into the first containing hole 63 and the second containing hole 64 to change the position of the prism base 3 in the containing groove 61, the angle of the optical axis between the first right-angle prism 320 and the objective lens module 5 and the angle of optical axis between the second right-angle prism 340 and the eyepiece lens module 4 are also changed. From the description above, it is known that the angle of optical axis between the second right-angle prism 340 and the eyepiece lens module is used for adjusting the depth of extending each first adjusting element 7 into the containing space 314 in order to change the position of an exit surface of the second right-angle prism 340 facing the eyepiece lens module 4. In the present invention, users can adjust the depth of extending each second adjusting element 81 into the first containing hole 63 and the second containing hole 64 to adjust the light at the incident surface of the first right-angle prism 320 and the light at the optical axis of the objective lens module 5 to be linear. Users adjust the depth of extending each first adjusting element 7 into the containing space 314 to set the light at the exit surface of the second right-angle prism 340 and the light at an optical axis of the eyepiece lens module 4 to be linear, and the light at the incident surface of the second right-angle prism 340 and the light at the optical axis of another portion of the Porro prism 330 to be linear.

While the invention has been described by means of specific embodiments, numerous modifications and variations could be made thereto by those skilled in the art without departing from the scope and spirit of the invention set forth in the claims.

What is claimed is:

1. A binocular telescope with an adjustable prism module, comprising two telescope tubes and a base shaft, and the two telescope tubes being pivotally coupled to two corresponding lateral sides of the base shaft respectively, and an end of each telescope tube having an eyecup unit, and each telescope tube comprising:
an eyepiece lens module, disposed at an end of the telescope tube and at a position proximate to the eyecup unit;
a telescope body, disposed inside the telescope tube and at a position between the eyecup unit and another end of the telescope tube;
an objective lens module, disposed inside the telescope body and at a position proximate to another end of the telescope tube; and
a prism module, disposed inside the telescope body and at a position proximate to the eyepiece lens module;
wherein the prism module comprises:
a prism base, movably disposed at a position between the eyepiece lens module and the objective lens module in the telescope body, and having a first opening disposed at the bottom of the prism base, a second opening disposed at the top of the prism base, and a containing space interconnected with each opening;
a first right-angle prism, disposed inside the prism base and at a position facing the first opening, and an incident surface of the first right-angle prism precisely facing the first opening, and corresponding to the objective lens module and an interval of the objective lens module through the first opening;
a Porro prism, disposed inside the prism base, and a portion of an incident surface of the Porro prism being fixed to an exit surface of the first right-angle prism; and
a second right-angle prism, disposed inside the prism base and at a position facing the second opening, and an exit surface of the second right-angle prism precisely facing the second opening, and an incident surface of the second right-angle prism being attached with another portion of the exit surface of the Porro prism, and corresponding to the eyepiece lens module, and an interval of the eyepiece lens module through the second opening;
wherein the position of the prism base inside the telescope tube is adjusted to change the angle of optical axis between the incident surface of the first right-angle prism and the objective lens module, and the position of the second right-angle prism inside the prism base is adjusted to change the angle of optical axis between the exit surface of the second right-angle prism and the eyepiece lens module, while changing the angle of optical axis between the incident surface of the second right-angle prism and another portion of the incident surface of the Porro prism.

2. The binocular telescope of claim 1, wherein the prism module further comprises a support base disposed inside the prism base, and having an oblique plane portion leaned against a reflecting surface of the second right-angle prism, and the support base has a hollow support pillar disposed at a position opposite to the second right-angle prism, and the hollow support pillar includes a first resilient element, and a free end of the first resilient element presses against the interior of the prism base; and
the top surface of the prism base includes at least one penetrating screw hole at the periphery of the second opening, and each penetrating screw hole is provided for passing a first adjusting element, and each first adjusting element is extended into the containing space, and pressed against the exit surface of the second right-angle prism.

3. The binocular telescope of claim 2, wherein the telescope body includes a containing groove with a shape corresponding to the prism base and facing an end of the eyepiece lens module, and a first containing hole, a second containing hole and a fixing through hole disposed at positions adjacent to a side wall of the telescope body in the containing groove, and the first containing hole and the second containing hole separately include a second resilient element; and
the prism base is disposed inside the containing groove, and includes a first connecting hole, a second connecting hole and a locking hole disposed around the periphery of the prism base and at positions facing the first containing hole, the second containing hole and the fixing through hole respectively; and
the locking hole is provided for passing a connecting element, and the connecting element is extended into the fixing through hole for adjusting a fulcrum of the prism base at a position inside the telescope tube, and the first connecting hole and the second connecting hole are provided for separately passing a second adjusting element, and each second adjusting element is extended separately into the first containing hole and second containing hole.
